(19) United States
(12) Patent Application Publication
(10) Pub. No.: US 2015/0315817 A1
(43) Pub. Date: Nov. 5, 2015

(54) ELECTROSTATIC LOCK

(71) Applicant: Evgenly Anatolevich OBZHIROV, (US)

(72) Inventor: Evgeniy Anatolevich OBZHIROV, Moscow (RU)

(21) Appl. No.: 14/650,582

(22) PCT Filed: Dec. 3, 2013
(86) PCT No.: PCT/RU2013/001086

§ 371 Date: Jun. 9, 2015

(30) Foreign Application Priority Data
Dec. 10, 2012 (RU) 2012152879

(51) Int. Cl. E05B 47/00

(52) U.S. Cl. CPC E05B 47/00; E05B 2047/0057

(57) ABSTRACT

The present invention concerns an electrostatic lock and relates to devices for fixing and holding in a fixed state relative to one another individual parts or elements of various mechanisms and devices with the possibility of the subsequent disengagement thereof, and functions by means of the electrostatic (Coulomb) force of attraction between electrodes charged with opposite electrical charges and separated by a sufficiently thin layer of dielectric material. The technical result of the present invention is the guaranteed fixing of the elements of the electrostatic lock upon closing. The primary technical solution of the present invention is the inclusion of electric valves (rectifiers) in the power supply circuit of the electrostatic lock, said valves (rectifiers) stabilizing the process of electric charge accumulation on the electrodes of the electrostatic lock and guaranteeing the closing thereof.

### TECHNICAL FIELD

Electrostatic lock (ESL) relates to devices for releasable fixing and holding individual parts or elements of various mechanisms and devices in a fixed state relative to each other, and operates by electrostatic (Coulomb) attraction force between the electrodes, charged with opposite electric charges and separated by a thin layer of dielectric. This device can serve as a locking device (lock), and also can be used for many other similar technical purposes.

### BACKGROUND

There are known such locking devices being active magnetic locks, based on the magnetic interaction between the electromagnet and the armature of a high magnetic permeability metal, between which an attraction force holding the lock closed appears as the electric current flows through the electromagnet. The main drawback of such a device is the necessity of a permanent power source: with no electrical power supply the lock turns unlocked, while the constant output of such devices usually does not exceed 5-10 W. For proper operation an ESL requires several times less electric energy, thus allowing for its operation within autonomous solutions, when it is difficult or impossible to provide power cabling; and hence enables to use renewable energy sources only, e.g. solar batteries; thermocouple units; low-power electrical generators, converting the mechanical motion energy of the parts and elements being fixed into the electrical one upon the ESL fixing (locking).

Despite some advantages over the magnetic locks currently the use of electrostatic force for fixing and holding the individual elements is of limited application, generally in the fields where a relatively small force is enough to achieve the desired effect. Electrostatic chucks mainly used to capture and hold silicon wafers have become widespread in the production of chips and other semiconductor devices. Also, so-called electrostatic holders for paper are commonly used as a rule in printing devices.

All these technical solutions have got common design elements: electrodes having one or more dielectric layers located therebetween so that if the electrodes are supplied with opposite electric charges by a power supply, they will be attracted to each other and attract the held object whereon under the influence of the electrodes electric field a polarization charge occurs attracted to the electrodes. There are known attempts to develop locking devices (locks), using electrostatic attraction forces for capturing and holding fixed (locked) corresponding locking devises (e.g., RF patent: RU 2158438 C1). Within these devices electrodes and dielectrics are used similarly for accumulating opposite polarity electric charges for the electrostatic capture and mutual fixation of the electrodes kinematically connected with the locking mechanism.

However, all these solutions have got a common and fundamental drawback: the electrodes being simply connected to the electrical power supply that is used or implied within such technical solutions, not only provides no required technical effect consisting in creation of stable charges and attraction forces therebetween for holding the electrodes fixed relative to each other, yet in many cases leads to fundamental inability to obtain such an effect. It is a guaranteed buildup of stable electrical charges providing a resistant to external and internal influences electrostatic attraction force between the ESL electrodes being fixed, that is a major technical effect of the present invention incorporating corresponding circuitry and other technical elements.

### DETAILED DESCRIPTION

According to FIG. 1, it is illustrated a device comprising of two equal flat conductive electrodes 1 (plates with an area S), separated with to equal dielectric 2 layers (with a specific dielectric constant ε_{d} and total thickness d) applied onto the electrodes. The plates can move relative to each other in a direction perpendicular to the plane of the plates, wherein a gap 3 thus formed between the dielectric layers is filled with air having a specific dielectric constant approximately equal to 1. In this form, the device is a capacitor of variable capacitance, the value of which depends on the air gap x between the electrodes:

$$C ( x ) = \frac{{ɛ}_{0} S}{d / ɛ d + x} . \qquad ( 1 )$$

Wherein ε₀ is permittivity of vacuum, equal to 8.85·10⁻¹² F/m. For x=0, the capacitor capacitance makes: C(0)=ε₀ε_{d}S/d . If electrodes charged with opposite electric charges Q of equal value, a potential difference U=Q/C(x) and an electrostatic (Coulomb) attraction force appear between the electrodes.

To determine this force magnitude a well-known principle of virtual work is used: the attraction force is equal to the ratio of an infinitesimal increment ΔW of the capacitor energy to the infinitesimal increment Δx, i.e. the derivative of the energy according to x coordinate (this is a simple consequence of the energy conservation law: the work of the external force is fully used for the capacitor electrostatic energy change). The capacitor energy for the constant charge makes:

$$W ( x ) = \frac{{Q}^{2}}{2 C ( x )} = \frac{{Q}^{2}}{2 {ɛ}_{0} S} ( d / {ɛ}_{d} + x ) . \qquad ( 2 )$$

Then, through substituting (1) in (2) and differentiating, one may obtain:

$${F}_{Q = Const} = \frac{d W}{d x} = \frac{{Q}^{2}}{2} \frac{d}{d x} ( \frac{1}{C ( x )} ) = \frac{{Q}^{2}}{2} \frac{1}{{ɛ}_{0} S} = \frac{{Q}^{2}}{2 C ( 0 )} \frac{{ɛ}_{d}}{d} = W ( 0 ) \frac{{ɛ}_{d}}{d} \qquad ( 3 )$$

Wherein W(0) is the capacitor energy for the position where x=0. It should be noted that the capacitor energy increases linearly with increasing x and the resulting attraction force does not depend on the air gap x, being constant determined by the device capacitance parameters and the size charges accumulated (or W(0)—being initial electrical energy, imparted to the device).

The equation for the attraction force (3) can be obtained directly as a product of the charge at one of the plates Q and the resulting electric field intensity E, which influences the charge and equals to the sum of the electric field intensity produced by a charge at the other electrode, and the intensity produced by the electric polarization vector of the dielectric.

The ratio of the attraction force to the charge energy F/W in (2) and (3) equals to the ratio ε_{d}/d that can reach enormous values. For example, if the specific dielectric constant ε_{d}=100 (ordinary capacitor ceramics), and the dielectric thickness d=10 μm (10⁻⁵ m), to create a holding force equivalent to 1 ton (10⁴ N) it is enough to impart to the capacitor the energy of 10⁻³ J. However, if it is just included into an electrical circuit the power supply (e.g., battery), the device wouldn't work consistently. The reason is that the attraction force between the ESL electrodes essentially depends on the stability of the charges at the electrodes: any possibility of a charge outflow from the electrodes, or the charge value variations caused by the transients that occur when charging electrodes, dramatically reduces the attraction force in the event of even very small (in comparison with the dielectric layer width) air gap between the electrodes.

To see this, consider the work of the above devices of FIG. 1, chargeable with a battery 4 having a constant EMF equal to U₀: for transferring the device from the open position (electrodes discharged and free to move relative to each other) to the closed position (x=0) it is connected to the battery 4 via a switch 5. For a theoretic electric circuit we obtain a stable charge at the capacitor Qₓ₌₀=C(0)U₀ for the initial time and an attraction force

$${F}_{x = 0} = W ( 0 ) \frac{{ɛ}_{d}}{d} ,$$

corresponding to the force of (3). Yet these expressions are valid only for the position x=0. The potential difference across the capacitor is now always constant and equal to U₀, if we start to increase the air gap x, the capacitor capacitance according to the Equation (1) will begin to decrease, and the capacitor charge equal to the product of voltage and capacitance will also start to decrease (along will the battery discharge):

Q(x)=C(x)U₀ .(4)

The capacitor energy

$$W ( x ) = \frac{C ( x ) {U}_{0}^{2}}{2}$$

will decrease as well. To obtain the attraction force between the capacitor plates one should substitute (4) into (3):

$${F}_{U = Const} = \frac{{Q ( x )}^{2}}{2} \frac{1}{{ɛ}_{0} S} = \frac{{U}_{0}^{2}}{2} \frac{{C ( x )}^{2}}{{ɛ}_{0} S} = \frac{{U}_{0}^{2}}{2} \frac{{ɛ}_{0} S}{{( d / {ɛ}_{d} + x )}^{2}} \qquad ( 5 )$$

As it is seen from the Equation (5), the attraction force decreases dramatically when even very small air gaps occur. So, in the above example ε_{d}=100 and d=10 μm (10⁻⁵ m), in the event of an air gap with a width of x=d/10=1 μm (10⁻⁶ m) the attraction force becomes 121 times less, and for x=d=10 μm (10⁻⁵ m) becomes more than 10000 less and equals to 1 N.

In this case, the instant the device is locking (x=0) after supplying a voltage from the battery to the circuit electrodes a transition process begins—there are gradually attenuating oscillations caused by the presence of an inherent capacitance, inductance and resistance values within the actual circuit and battery, except the capacitance of the fixed electrodes, which, altogether will determine the oscillation frequency co and the attenuation rate β, wherein the initial amplitude will depend on the initial conditions (the value of U₀):

Q=C(0)U=C(0)U₀(1−e^{-βt} cos ωt). (6)

In a first approximation the actual electric circuit can be represented by an equivalent circuit comprising series-connected inductance Lₖ, capacitance Cₖ and resistance Rₖ, i.e. in the form of a simple oscillator circuit wherein for ω and β it is valid:

$$β = - \frac{{R}_{k}}{2 {L}_{k}} , ω = \sqrt{\frac{1}{{L}_{k} {C}_{k}} - {( \frac{{R}_{k}}{2 {L}_{k}} )}^{2}} .$$

The Equation (6) shows that when the power is on at the beginning of the transition process, even when the attenuation can be neglected, the magnitude of the charge at the electrodes will range from 0 to 2Q₀=2C(0)U₀, and it will occur at times when the electrostatic attraction force is proportional to the square of the charge and equals to zero. Any impact on the electrodes at this point will result in air gaps, the attraction force rapid decrease according to the Equation (5), and will make further fixation of the ESL electrodes to each other impossible without application of additional external force, i. e. the device won't be able to perform its function.

The factors creating the repulsive force between the electrodes, when the charges at the electrodes reduced to zero, are as follows: an elastic force opposing the electrostatic attraction force, deforming the electrodes and dielectric, which in this case are similar to a compressed spring; a magnetic Ampere force arising between symmetrically arranged electrodes, at the same time providing opposite currents of the same magnitude passing therethrough. These currents will fluctuate out of phase with the charge values and will take the maximum in absolute magnitude by the time when the charges at the electrodes equal to zero.

Based on the above, it can be concluded that the device of FIG. 1 can not perform its basic function—the fixation of electrodes. To achieve this technical effect and the efficient ESL operation it is necessary to exclude the currents, reverse to the ones of the electrodes being charged. It's enough to include electric valves (rectifiers) into the operating electrical ESL as devices having non-linear current-voltage characteristics: a minimal resistance in the forward direction and maximal possible otherwise (rectifier—a nonlinear circuit component that allows more current to flow in one direction than in the other, as stated in McGraw-Hill Concise Encyclopedia of Engineering).

### Basic Embodiments

For example, a rectifier diode can be such a device. According to FIG. 2 a pair of such valves (rectifiers) with a reference number 6 integrated in series with the electrodes and the power supply into the ESL circuit, eliminates the reverse current and trap the charges at the electrodes, providing a constant attraction force therebetween according to Equation (3), and also serve as a filter that neutralizes transient oscillations occurred when the power source is turned on. Thus, FIG. 2 shows a ESL guaranteeing the achievement of the desired technical effect, comprising two electrodes 1, a dielectric 2, applied to the electrodes, wherein the electrodes can be tightly adjoin each other with their sides covered with a dielectric providing no air gaps, and at least one of the electrodes may move relative to the other one forming a gap 3 therebetween; two electric valves (rectifiers) 6, each connected in series with its electrodes as close to the electrode so as to allow the electrodes to accumulate opposite electric charges and to exclude the possibility of reverse current; a switch (electric key) 5, closing the electrodes and the electric valves (rectifiers) into a single circuit with an electrical power supply 4 while the ESL is locked, and causing short-circuit of the electrodes (either through a branch resistance 7) in the other position when ESL is unlocked.

FIG. 3 shows an ESL, besides the electrodes 1 chargeable directly from the electrical power supply (primary electrodes) further comprising a secondary electrode 12, separated from the primary electrodes with dielectric 2 layers tightly adjoined thereto at a fixed (locked) state of the ESL, so when the electric charges are accumulated on the primary electrodes the secondary charges induced (stimulated) by the primary charges electric fields on the primary electrodes are accumulated on the secondary electrode on its contact surface with the primary ones (through the dielectric); wherein the induced secondary charges are of opposite polarity with respect to the primary charges inducing them thus creating an electrostatic attraction force between the primary and secondary electrodes. Operation of such ESL is completely similar to that shown in FIG. 2, and in many cases it is more convenient and easier.

### Preferred Embodiment

For ESL operation (FIG. 2 or FIG. 3) it is very important to include one of the electrodes into a turning pair (for example, by means of a ball coupling) thus enabling the electrode to make small turns for fine adjustment to the other electrode when locking ESL. Otherwise, the inevitable technical tolerances during the assembling of ESL elements will lead to fatal air gaps prohibit ESL from normal operation. For example, in the case of flat electrodes when one electrode's plane becomes non-parallel to another electrode's one 10⁻³ radians angle is enough for 1 cm long electrode in order to create an air gap up to 10 μm between the electrodes that merely eliminates ESL operation. Therefore, the best embodiment of the invention must contain at least one of the electrodes included into the turning pair as described above. In addition, according to the Equation (3) the attraction force between the electrodes, ceteris par/bus, is the higher, the thinner is the dielectric layer between the electrodes d and the greater is its specific dielectric constant ε_{d}. Therefore, the best ESL embodiment according to be implemented should contain a dielectric suitable for a thin film to be produced thereof and having the greatest possible ratio ε_{d}/d compared with other materials.

### Further Embodiments

As known, electric valves (rectifiers) are divided into the following main types:

electrolytic valves (rectifiers) with valve effect on the metal and electrolyte interface, ionic valves (rectifiers) with valve effect at the metal and gas interface, electric vacuum valves (rectifiers) with valve effect on the metal and vacuum interface, semiconductor valves (rectifiers). Any of them can be used in an ESL, yet the semiconductor diodes and thyristors being the simplest and most promising ones.

Also, to supply ESL with charges it is advantageous to use autonomous power sources, such as a photovoltaic generator (solar batteiy); a thermoelectric generator; a chemical current source—as a galvanic cell; a chemical current source—as an accumulator battery; an electromechanical generator—as a converter meant for converting the mechanical motion energy generated when an electrode or a group of electrodes comes close to another electrode or group of electrodes upon the ESL fixing (locking), into electrical energy. In the latter case, a piezoelectric generator or a capacitance electric generator can be used in the function of an electromechanical generator.

### BRIEF DESCRIPTION OF THE DRAWINGS

FIG. 1—shows a device comprising electrodes 1, dielectric 2, separating electrodes, a gap 3 formed between the dielectrics 3 that can be reduced to zero, a power supply 4 and an electric key 5, wherein the device is not able to function as an electrostatic lock autonomously;

FIG. 2—shows an electrostatic lock (ESL), comprising all the above elements of the device of FIG. 1, further comprising electric valves (rectifiers) 6, allowing for the technical effect required when locking the ESL, and comprising a branch resistance;

FIG. 3—shows an electrostatic lock (ESL), unlike the ESL of FIG. 2 having both the primary electrodes 1, directly chargeable from the electrical power supply, and a secondary electrode 12 wherein secondary charges are induced with the charges of the primary electrodes.

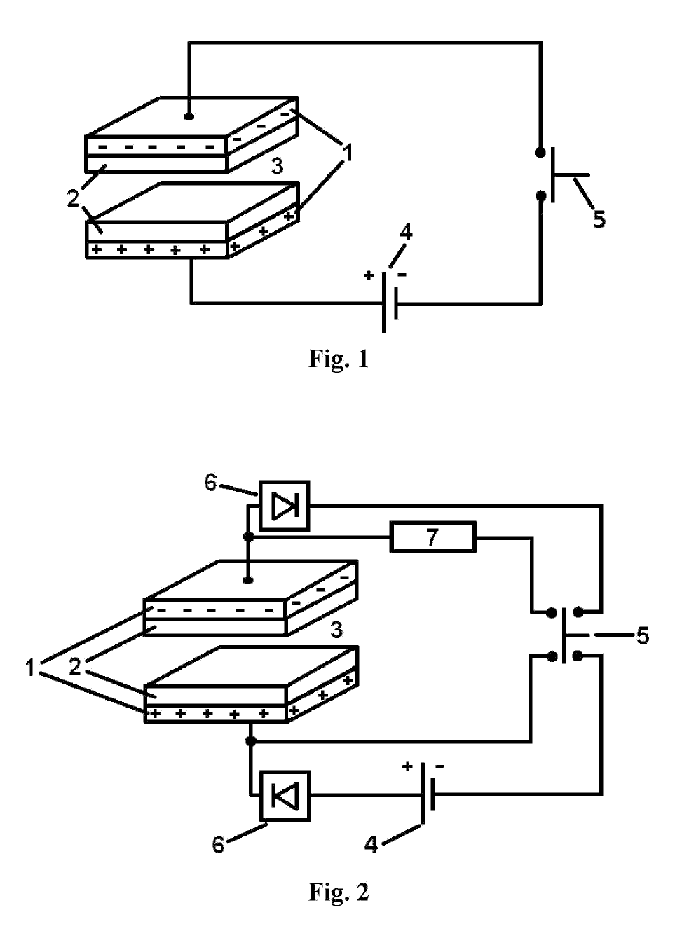

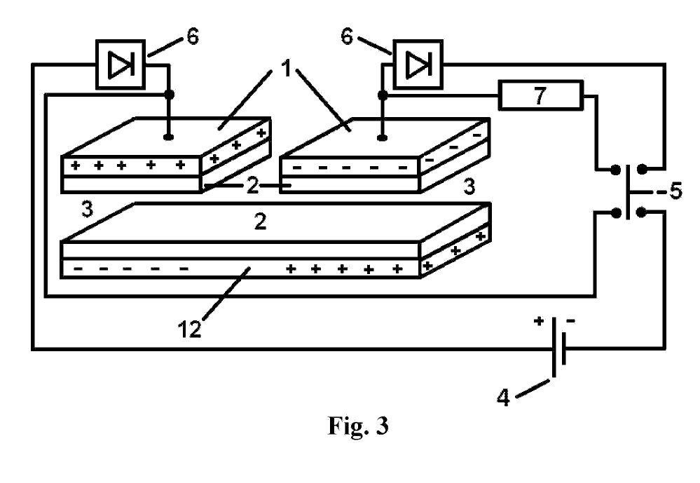

1. Electrostatic lock (ESL)—a device for releasable fixing and holding individual parts or elements of various mechanisms and devices in a fixed state relative to each other, by means of electrostatic (Coulomb) attraction force,
comprising fixable electrodes, mechanically and kinematically connected with parts or elements to be mutually fixed and connectable to an electrical power supply for imparting to the electrodes opposite charges and comprising at least one dielectric layer separating the electrodes to be oppositely charged, so as while fixing (locking) the ESL oppositely charged electrodes tightly adjoin each other through the dielectric they are separated with,
characterized in that, at least two electric valves (rectifiers) are used for connecting the ESL electrodes to the electrical power supply, each valve (rectifier) being connected directly to its electrode or group of electrodes in order to provide charging thereof with electric charge of a certain polarity (opposite to the one of another electrode or group of electrodes) and to eliminate or minimize any possible current occurrence in the direction opposite to the electrodes' current when being charged.

2. Electrostatic lock (ESL) of claim 1, characterized in that besides the electrodes, chargeable directly from the electrical power supply (primary electrodes) it further comprises one or more mutually short-circuited or grounded electrodes (secondary electrodes), separated from the primary electrodes with one or more dielectric layers and tightly adjoined thereto at a fixed (locked) state of the ESL, so when the electric charges are accumulated on the primary electrodes, secondary charges induced (stimulated) by electric fields of the primary charges accumulated on the primary electrodes are accumulated on the secondary electrodes on their contact surface with the primary ones (through the dielectric); wherein the induced secondary charges are of opposite polarity with respect to the primary charges inducing them thus creating an electrostatic attraction force between the primary and secondary electrodes.

3. Electrostatic lock (ESL) of claim 1, characterized in that at least one of the electrodes is included into the turning pair thus enabling the electrode to make small turns relative to an axis or a point of fixing to one of the mechanism parts to be fixed for fine adjustment and tight adjoining to another electrode when fixing (locking) the ESL.

4. Electrostatic lock (ESL) of claim 1, characterized in comprising at least one switch (electric key) to be turned into open position for separating (unlocking) the ESL electrodes thus providing complete discharge for both electrodes through closing the electrodes with each other or with a ground loop; after unlocking the ESL the switch is returned to initial closed position.

5. Electrostatic lock (ESL) of claim 1, characterized in that electrolytic valves (rectifiers) with valve effect on the metal and electrolyte interface; or ionic valves (rectifiers) with valve effect at the metal and gas interface; or electric vacuum valves (rectifiers) with valve effect on the metal and vacuum interface; or semiconductor valves (rectifiers) are used as electric valves (rectifiers).

6. Electrostatic lock (ESL) of claim 5, characterized in that semiconductor diodes and thyristors are used as semiconductor valves (rectifiers).

7. Electrostatic lock (ESL) of claim 1, characterized in comprising an autonomous electric power source: a photovoltaic generator (solar battery); or a thermoelectric generator; or a chemical current source—a galvanic cell; or a chemical current source—a battery; or an electromechanical generator—a converter meant for converting the mechanical motion energy generated when an electrode or a group of electrodes comes close to another electrode or group of electrodes upon the ESL fixing (locking), into electrical energy.

8. Electrostatic lock (ESL) of claim 7, characterized in comprising a piezoelectric generator or a capacitance electric generator used as an autonomous electrical power source (an electromechanical generator).
